(19) United States
(12) Patent Application Publication
(10) Pub. No.: US 2021/0390793 A1
(43) Pub. Date: Dec. 16, 2021

(54) METHOD AND SYSTEM FOR TOUCHLESS PARKING FACILITY

(71) Applicant: FlashParking, Inc., Austin, TX (US)

(72) Inventor: Steven Benz, Rochester, NY (US)

(73) Assignee: FlashParking, Inc., Austin, TX (US)

(21) Appl. No.: 17/343,492

(22) Filed: Jun. 9, 2021

Related U.S. Application Data
(60) Provisional application No. 63/037,359, filed on Jun. 10, 2020.

(51) Int. Cl. G07B 15/06; G07B 15/04; G08G 1/017; G08G 1/042; G06Q 20/18; G06Q 20/20

(52) U.S. Cl. CPC G07B 15/063; G07B 15/04; G06Q 20/209; G08G 1/042; G06Q 20/18; G08G 1/017

(57) ABSTRACT

This disclosure relates to methods and systems for touchless parking facility entry, wherein the parking facility entry system uses a detector to unlock a motion sensor on a kiosk responsive to a determination or signal that is located next to the kiosk. The driver of the vehicle may then make some motion which, when detected by the motion sensor, will trigger the kiosk to dispense a parking ticket for the vehicle. The system may then open a gate to provide the vehicle with access to the parking facility.

### PRIORITY STATEMENT

### Under 35 U.S.C. § 119 & 37 C.F.R. § 1.78

This non-provisional application claims priority based upon prior U.S. Provisional Patent Application Ser. No. 63/037,359 filed Jun. 10, 2020 in the name of Steven Benz entitled “METHOD AND SYSTEM FOR TOUCHLESS PARKING FACILITY ENTRY,” the disclosures of which are incorporated herein in their entirety by reference as if fully set forth herein.

### BACKGROUND OF THE INVENTION

Parking services regularly utilize automated kiosks in order to monitor and regulate the entry and exits of vehicles in a parking facility. In order to enter a parking facility such kiosks generally require the driver of a vehicle to press a button in order to generate a parking ticket linked to the time that the vehicle is permitted access to the parking facility. Once a parking ticket has been generated by the kiosk, a gate is opened to permit the vehicle's entry to the parking facility. When the driver wishes to exit the parking facility, they may be required to insert the parking ticket into a kiosk and pay the fee associated with the duration of their vehicle's stay in the parking facility. Alternately, the parking ticket may be paid at a pay station prior to its insertion into the kiosk, after which the kiosk will validate the payment of the ticket. Once payment has been submitted and validated a gate is opened to permit the vehicle's exit from the parking facility.

Kiosks known in the art generally require the driver manually actuate a button to request the generation of a parking ticket. Such systems require each driver entering a parking facility to come into physical contact with a button that has been touched by every driver who entered the parking facility before them.

As is well known, germs and/or viruses can (1) be deposited on a surface by an interaction between the first individual and the surface, (2) survive on a surface for extended periods of time, and (3) be transmitted to a second individual, who subsequently touches said surface. Accordingly, the use of a kiosk, which has a manual button that must be pressed to operate the kiosk, exposes each person using the kiosk to the possibility of exposure to germs and/or viruses from any previous users.

It is an objective of this disclosure to provide for systems and methods which reduce the risk of disease transmission from one kiosk user to another by replacing the manual, button-based, parking facility entry systems with ones that have touchless user interface.

### SUMMARY OF THE INVENTION

Embodiments of the present invention relate generally to the methods and systems for parking facility management. More specifically those embodiments relate to a parking system in which a vehicle operator can touchlessly access a parking facility. In general, the systems and methods discussed herein teach parking facility access areas being equipped with one or more detectors configured to determine whether the vehicle entering the parking facility is positioned adjacent to a kiosk. Detectors may also include, for example, license plate recognition cameras and vehicle type detection cameras and sensors. If a vehicle is positioned adjacent to the kiosk, a detector, such as a parking induction loop, may detect the presence of the vehicle, which causes the motion sensor inside the kiosk to be unlocked. The vehicle's operator may then make a motion in front of the sensor, such as by waving a hand, whereupon a ticket dispenser in the kiosk is activated.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a schematic depiction of one embodiment of the parking management system of the present invention in which a vehicle enters a parking facility, in accordance with embodiments;

FIG. 2 depicts an alternate embodiment of a system for touchless entry to a parking facility, in accordance with embodiments;

FIG. 3 shows an exemplary kiosk in accordance with embodiments of a system for touchless entry of a parking facility;

FIG. 4 shows a flow diagram for a basic method for touchless entry of a parking facility, in accordance with embodiments;

FIG. 5 shows a flow diagram for an advanced method for touchless entry of a parking facility, in accordance with embodiments; and

FIG. 6 depicts an alternate embodiment of a flow diagram for an advanced method for touchless entry of a parking facility, in accordance with embodiments.

### DETAILED DESCRIPTION OF ILLUSTRATIVE EMBODIMENTS

Reference now should be made to the associated figures, in which the same reference numbers are used throughout the different figures to designate the same components. Dashed lines indicate elements that may be considered optional to the fundamental underlying function of the systems and methods disclosed herein, but which may be incorporated into such systems and methods and/or the claims therefor.

The present invention is directed to improved methods and systems for, among other things, touchlessly accessing parking facilities. The configuration and use of the presently preferred embodiments are discussed in detail below. It should be appreciated, however, that the present invention provides many applicable inventive concepts that can be embodied in a wide variety of contexts other than those specifically described herein. Accordingly, the specific embodiments discussed are merely illustrative of specific ways to make and use the invention, and do not limit the scope of the invention.

In the associated Figures, broken lines may be used to denote elements of systems or steps of methods that may optional, advantageous, or specific to particular embodiments of such systems and methods. Such indications are included solely to provide additional information and assist in better understanding such systems and methods and are not intended to be read as a means of limiting the scope of the claims related to this application.

In addition, the following terms shall have the associated meaning when used herein:

“communications network” means any means of communication suitable to pass relevant information between one or more elements of the systems discussed in this disclosure, including but not limited to: the Internet, direct electrical or optical connection, a LAN, a wireless network, etc.

“mobile device” means any portable computing device, typically having a display screen with touch input and/or a miniature keyboard, and includes, without limitation, the head unit.

“parking facility” means an indoor or outdoor area for parking vehicles, including, for example, a parking garage, parking lot, parking ramp, car park and the like.

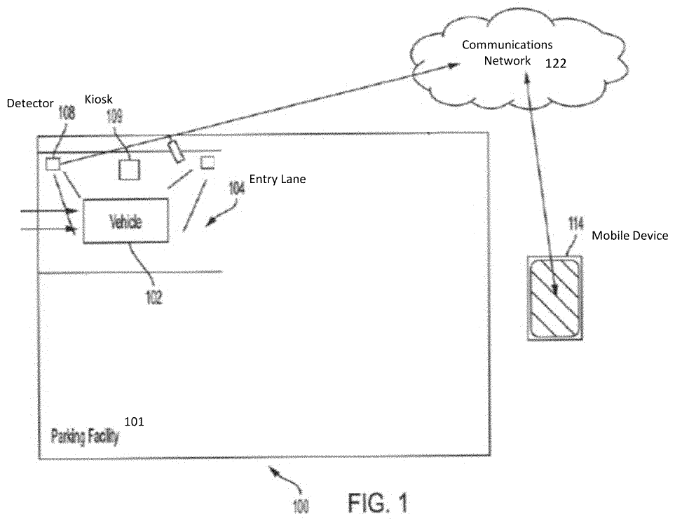

Referring now to FIG. 1 which depicts a parking facility 101 configured with one embodiment of the present invention, system 100. System 100 may comprise detector 108 and kiosk 109. System 100 may begin to operate when vehicle 102 enters entry lane 104 of parking facility 101. A display on a kiosk 109 may present the driver of vehicle 102 the current rate for parking in parking facility 101. In some embodiments a detector 108 may determine that vehicle 102 is positioned adjacent to kiosk 109. Detector 108 may either send this information locally to kiosk 109 or to a remote location (not shown).

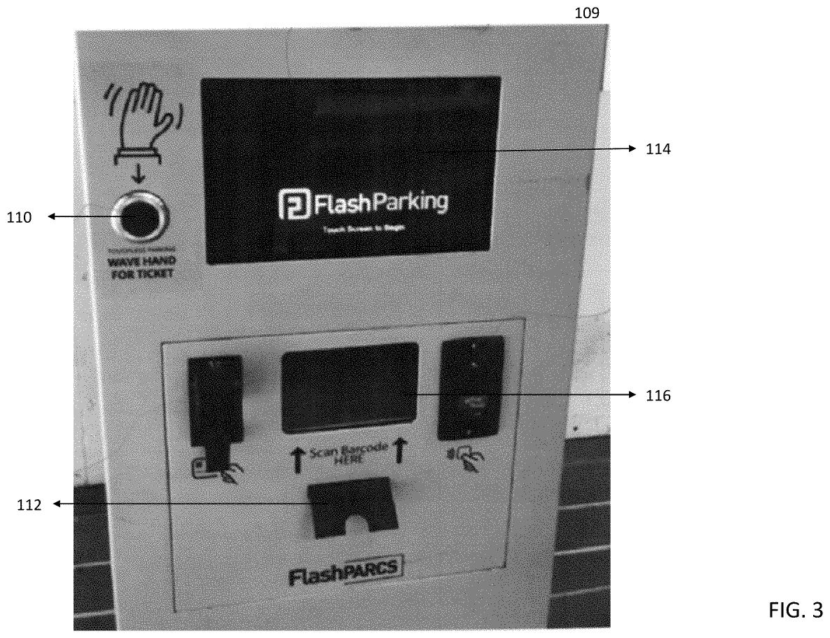

It is understood that system 100 and/or its constituent components may comprise additional elements as desirable. For example, referring now to FIG. 3, kiosk 109 may comprise visual display 114, which may display information to the driver of vehicle 102, or barcode scanner 116, which may operate as an alternate mechanism for the touchless transfer of parking ticket and/or vehicle information between the system and the driver of vehicle 102.

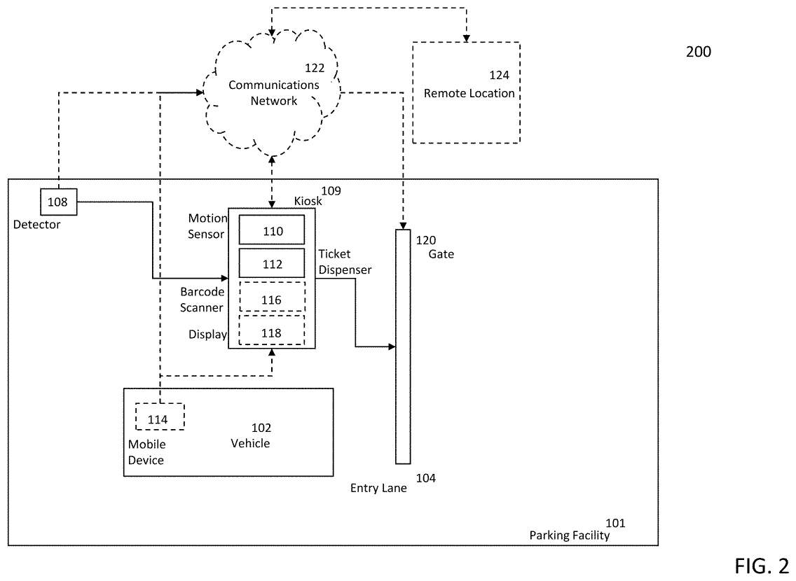

FIG. 2 comprises a block diagram of an embodiment of a system for touchless entry to a parking facility, namely system 200, wherein when vehicle 102 enters parking facility 101 detector 108 may detect vehicle 102 and determine whether vehicle 102 is in a particular position, such as entry lane 104 or proximate to kiosk 109. When detector 108 determines vehicle 102 is in a predetermined location, detector 108 may send a signal to kiosk 109 unlocking motion sensor 110. Once motion sensor 110 is unlocked the driver of vehicle 102 may make a motion or send a signal from mobile device 114 to signal kiosk 109 to provide vehicle 102 with a ticket via ticket dispenser 112. Once a ticket has been dispensed the system may actuate gate 120, or some other such parking facility hardware, and vehicle 102 is permitted entry to parking facility 101.

Embodiments of the system depicted in FIG. 2 may provide for detector 108 to gather and send vehicle information for vehicle 102, such as its license plate number or other identifying features (collectively with the location regarding the determination of the location of vehicle 102 “vehicle information”) to a location such as kiosk 109, mobile device 114, or remote location 124 to be processed or displayed. Remote location 124 may have a record of vehicles which are not authorized to access parking facility 101 against which the vehicle information about vehicle 102 may be analyzed. If such analysis determines vehicle 102 is not authorized access to parking facility 101, remote location 124 may not send an unlock signal to motion sensor 110, or may send a denial signal to the system 200, thereby denying vehicle 102 access to parking facility 101.

Alternate embodiments of system 200 may allow for motion sensor 110 to be unlocked via signal from a cell phone, Bluetooth, a mobile app, the reading of a barcode on a ticket or screen, or otherwise such as from a mobile device 114. Other embodiments may require unlocking signals from both detector 108 and mobile device 114 to unlock motion sensor 110. Signal passing between components of the system may pass locally between such components as are required to effectuate operation of the system. For an example of such a local configuration, in FIG. 2 detector 108 is depicted as directly communicably connected to kiosk 109, which itself is then communicably connected to gate 120, each of which being a direct connection not passing through communications network 122. Alternatively, FIG. 2 also depicts a distributed configuration of the system in which any one or more of the detector 108, kiosk 109, gate 120, mobile device 114, and remote location 124 may be communicably interconnected through communications network 122 (the internet, or intra-net, LAN, WLAN, etc.) to suitably perform system level functions.

In yet another embodiment, in addition or alternatively to detecting the presence of a vehicle 102 at the entrance to the parking facility, the vehicle's operator may be able to send a signal through a mobile device 114 through the communication network 122 to kiosk 109 unlocking the motion sensor 110 inside the kiosk 109, thereby allowing the operator of vehicle 102 to request a ticket by, for example, waving a hand in front of motion sensor 110 or using barcode scanner 116 to read a barcode off of a ticket or a screen of mobile device 114.

Those skilled in the art will appreciate that there may be situations with various fail conditions, or prerequisites. For example, unless detector 108 determines the presence of vehicle 102 in a proper location, motion-sensor 110 inside kiosk 109 may not be unlocked and tickets may be prevented from being dispensed from kiosk 109. Alternately, the system may deny vehicle 102 from entering parking facility 101 responsive to a deny signal from remote location 124. It is envisioned that such deny signals may be responsive to system information, such as the association of vehicle information from vehicle 102, whether as collected by detector 108 or provided via mobile device 114, with an access restriction.

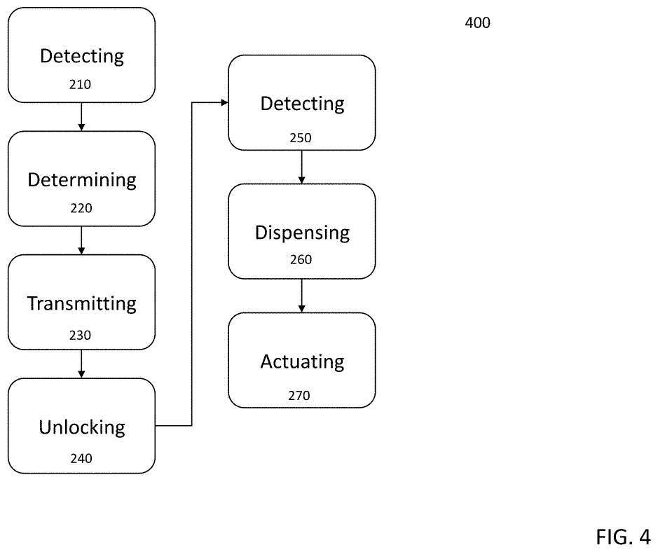

Referring now to FIG. 4, a basic method 400 for touchless parking facility entry may comprise the steps of: detecting 210 a vehicle; determining 220 if the vehicle is in a predetermined location; transmitting 230 an unlock signal responsive to determining 220; unlocking 240 a motion sensor responsive to receipt of the unlock signal; detecting 250 motion via the unlocked motion sensor; dispensing 260 a ticket responsive to detecting 250; and actuating 270 a parking facility system, such as a gate, responsive to one of detecting 250 and dispensing 260.

The embodiment of a method for touchless parking facility entry depicted in FIG. 2, method 200, represents only generally essential elements off of which any arbitrary number or combination of additional elements or complexities as may be required by the system design specifications. It is noted that method 200 provides an example of a method for touchless parking facility entry suitable for systems with their constituent components are connected either directly to one another, or via a local network.

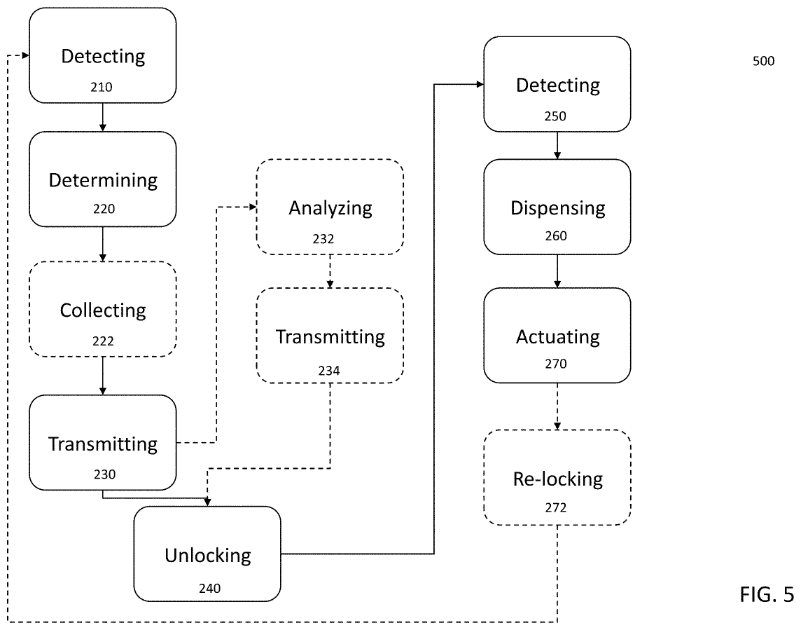

FIG. 5 depicts an alternate, more complex, embodiment of a method for touchless parking facility entry, method 500. Method 500 comprises the same basic steps of detecting 210, determining 220, transmitting 230, unlocking 240, detecting 250, dispensing 260, and actuating 270, and for the sake of additional functionality comprises the additional steps of collecting 222, analyzing 232, transmitting 234, and re-locking 272.

In the following paragraphs, FIG. 5 will be used in reference to the method steps being discussed, and FIG. 2 will be referenced regarding the physical elements of exemplary system 200 for performing said method. The method 500 embodiment comprises the following steps. Detecting 210 vehicle 102 via detector 108. Determining 220 using detector 108 when vehicle 102 enters an approved location, such as entry lane 114 proximate kiosk 109. Collecting 222 vehicle information from vehicle 102 via detector 108. Transmitting 230 an unlock signal from detector 108 to motion sensor 110. In addition or in the alternative to direct transmission of an unlock signal from detector 108 to motion sensor 110, transmitting 230 may comprise transmitting vehicle information, including any unlock signal or other determined or collected information, from detector 108 to remote location 124 via communications network 122. Analyzing 232 of vehicle information may occur, for example, vehicle information from vehicle 102, obtained via detector 108, may be used to individually identify vehicle 102 and call-up an account associated with the particular vehicle 102 for additional information which may be useful for enhanced functionality of the system, such as to confirm parking authorization for vehicle 102. In embodiments, analyzing 232 of vehicle information received from detector 108 may be performed at remote location 124. If analyzing 232 indicates that vehicle 102 has authorization to access parking facility 101, transmitting 234 may comprise transmitting an unlock signal from remote location 124, where analyzing 232 occurred, to motion sensor 110 through communications network 122. If analyzing 232 determines that vehicle 102 does not have authorization to access parking facility 101, transmitting 234 may not occur, or may comprise the sending of a denial signal instructing system 100 to deny access to vehicle 102 to one or more competent elements of system 100 at any point before actuating 270. Unlocking 240 motion sensor 110 may occur responsive to the receipt of a valid unlock signal. Once unlocked, motion sensor 110 may begin scanning for motion. Detecting 250 may occur when unlocked motion sensor 110 identifies motion, such as from the driver of vehicle 102. Dispensing 260 a parking ticket for vehicle 102 via ticket dispenser 112 may occur responsive to detecting 250. Actuating 270 of a parking system, such as gate 120 may occur responsive to one or more of detecting 250, dispensing 260, or some subsequent requirement, unless a denial signal related to vehicle 102 has been received by system 100.

Assuming analyzing 232 confirms unlock signal issuance requirements and does not detect any access restriction or other condition precipitating the issuance of a denial signal, actuating 270 of gate 120 should be performed and vehicle 102 may be allowed to access parking facility 101. Actuating 270, in addition to comprising opening gate 120, may comprise closing gate 120, which may be performed responsive to a suitable close condition or command occurring subsequent its opening. Similarly, re-locking 272 of motion sensor 110 may occur responsive to a suitable lock condition or command, such as a command from remote location 124, which may occur at any time after unlocking 240.

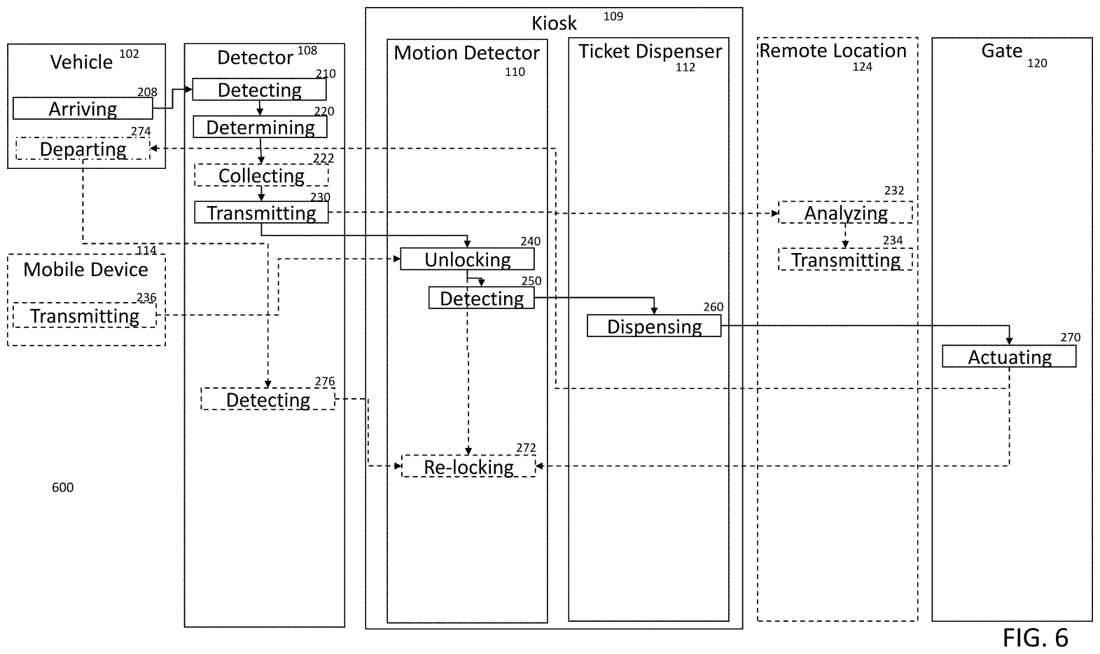

FIG. 6 depicts an alternate embodiment of a flow diagram showing an exemplary embodiment of a method for touchless parking facility entry, method 600. The design of the diagram of method 600 depicted in FIG. 6 is configured to better illustrate which elements of hardware may be performing which method steps. In the embodiment of a method for touchless parking facility entry, depicted as method 600, with vehicle 102 arriving 208 at a parking facility. Detector 108 may perform the steps of detecting 210 vehicle 102, and subsequently determining 220 when vehicle 102 is located in an appropriate location, collecting 222 vehicle information from vehicle 102, and transmitting said information to at least one of motion sensor 110 in kiosk 109 and remote location 124. Analyzing 232 vehicle information for vehicle 102 may be performed at remote location 124. Responsive to analyzing 232, transmitting 234 may occur, sending one or more of an unlock signal, a denial signal, or any such suitable command signal to a component of the system. Unlocking of motion sensor 110 may occur responsive to its receipt of an unlock signal from at least one of detector 108, remote location 124, or mobile device 114. Once unlocked, motion sensor 110 may undergo re-locking 272 responsive to the completion of a set of predetermined conditions, such as the expiration of a set time period, or to a command signal. Motion detector 110 may engage in detecting 250 motion, such as that of a hand signal performed by a driver of vehicle 102, after the step of unlocking 240 has occurred, and before the step of relocking 272 occurs. Ticket dispenser 112 may engage in the step of dispensing 260 a ticket for vehicle 102. Actuating 270 of gate 120 may occur responsive to one or more of motion sensor 110 detecting 250 motion, ticket dispenser 112 dispensing 260 a ticket, or another suitable condition, such as driver of vehicle 102 removing the dispensed ticket from ticket dispenser 112. Vehicle 102 may then engage in departing 274 the transactional location and enter the parking facility.

Method 600 includes the ability for unlocking 240 to occur responsive not only to transmitting 230 from detector 108 or transmitting 230 from remote location 124, but also to transmitting 243, which may be performed by mobile device 114. Method 600 also depicts a step for relocking 272 of motion sensor 110 to occur to a signal resulting from detector 108 detecting 276 the lack of the presence of a vehicle 102 in the appropriate transaction location.

While the present system and method has been disclosed according to a preferred embodiment of the invention, those of ordinary skill in the art will understand that other embodiments have also been enabled. Even though the foregoing discussion has focused on particular embodiments, it is understood that other configurations are contemplated. In particular, even though the expressions “in accordance with embodiments,” “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of methods for parking facility entry known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

What is claimed is:

1. A system for touchless parking facility entry comprising:
a. a detector configured to receive input indicating the presence of a vehicle at a location;
b. a kiosk comprising:
i. a motion sensor configured to activate responsive to the detector detecting the presence of a vehicle at the location; and
ii. a ticket dispenser configured to dispense a ticket responsive to the motion sensor detecting motion; and
c. a communications channel configured to transfer information between the detector and the kiosk.

2. The system of claim 1, wherein the location comprises a location proximate the kiosk.

3. The system of claim 1, wherein the detector comprises an inductive-loop detector.

4. The system of claim 1, wherein the detector comprises a camera configured to capture vehicle information from the vehicle at the location.

5. The system of claim 1, wherein the input received by the detector comprises a signal from a mobile device.

6. The system of claim 1, wherein the communications channel comprises a local network.

7. The system of claim 1, wherein the communications channel comprises a wireless network.

8. A method for touchless parking facility entry comprising:
a. determining the presence of a vehicle at a location adjacent a kiosk via a detector;
b. unlocking a motion sensor in the kiosk responsive to a positive determination by the detector;
c. detecting movement via the unlocked motion sensor;
d. dispensing a ticket via a ticket dispenser in the kiosk responsive to the detecting of movement by the unlocked motion sensor.

9. The method of claim 8, further comprising actuating a gate responsive to dispensing a ticket.

10. The method of claim 8, further comprising:
re-locking the motion sensor after one or more of:
a. the motion sensor failing to detect motion for a predetermined period after its unlocking;
b. the detector determining a lack of presence of a vehicle at the location of the kiosk;
c. the detector determining that the vehicle exited the location adjacent the kiosk; and
d. the receipt of a re-lock signal from a remote location.

11. The method of claim 8, additionally comprising the steps of:
e. transmitting determination information comprising the positive determination from the detector to the kiosk prior to unlocking the motion sensor.

12. The method of claim 11, wherein the transmitting step is performed via a communication channel between the detector and the kiosk.

13. The method of claim 11, wherein the determination information comprises vehicle information, and wherein the transmitting step comprises transmitting the determination information to a remote location prior.

14. The method of claim 13, wherein one or more of the steps of unlocking the motion sensor, detecting movement, and dispensing a ticket is interrupted by a denial instruction transmitted from the remote location to the kiosk.

15. The method of claim 14, wherein the denial instruction is transmitted responsive to analysis of the vehicle information.
